(19) United States
(12) Patent Application Publication
(10) Pub. No.: US 2008/0021692 A1
(43) Pub. Date: Jan. 24, 2008

(54) METHOD FOR PERFORMING POWER SIMULATIONS ON COMPLEX DESIGNS RUNNING COMPLEX SOFTWARE APPLICATIONS

(76) Inventors: Rajat Chaudhry, Austin, TX (US); Sang H. Dhong, Austin, TX (US); Gilles Gervais, Austin, TX (US); Danny J. Klema, Rochester, MN (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/459,060

(22) Filed: Jul. 21, 2006

(51) Int. Cl. G06F 17/50

(52) U.S. Cl. 703/18

(57) ABSTRACT

A power estimation system uses a hardware accelerated simulator to advance simulation to a point of interest for power estimation. The hardware accelerated simulator generates a checkpoint file, which is then used by a software simulator to initiate simulation of the processor design model for power estimation. An on-the-fly power estimator provides power calculations in memory. Thus, the power estimation system described herein isolates instruction sequences to determine portions of software code that may consume excess power or generate noise and to provide a more accurate power estimate on the fly.

### BACKGROUND

1. Technical Field

The present application relates generally to an improved data processing system and method. More specifically, the present application is directed to a system and method for performing power simulations on complex designs running complex software applications.

2. Description of Related Art

In circuit design, power consumption is a significant factor, particularly for data processors. Chip power density has increased due to increased chip frequency and leakage due to scaling. That is, processor chips have become faster and smaller, causing a significant increase in power consumption. A faster chip frequency causes switches to change state more frequently, which consumes energy. Making chips smaller results in components being closer together and having narrower channels. This results in current leakage.

Traditionally, processor designs that target low power consumption have been reserved for battery powered devices to increase battery life. However, higher power density is driving up other costs for even wall socket powered devices, such as desktop computers and game consoles. For example, higher power chips require more costly packaging. Also, power consumption results in heat generation; therefore, higher power devices require more costly, and larger, cooling systems. End users are concerned with power consumption due to energy costs.

Software simulators using hardware models are instrumental in power estimations. However, today's complex processor designs cannot be quickly simulated. Running real applications that require several billion cycles to execute on a software based simulator is prohibitive. Therefore, the current approach is to divide the design into smaller pieces, run the smaller applications, and then sum the pieces in the end. This is prone to error. In addition, simulations for power estimations produce large data volumes, which can be problematic.

### SUMMARY

The illustrative embodiments recognize the disadvantages of the prior art and provide a power estimation system that uses a hardware accelerated simulator to advance simulation to a point of interest for power estimation. The hardware accelerated simulator generates a checkpoint file, which is then used by a software simulator to initiate simulation of the processor design model for power estimation. An on-the-fly power estimator provides power calculations in memory. Thus, the power estimation system described herein isolates instruction sequences to determine portions of software code that may consume excess power or generate noise and to provide a more accurate power estimate on the fly.

In one illustrative embodiment, a method for performing power estimation for a processor design model running a workload software application is provided. The method comprises loading the processor design model into a hardware accelerated simulator, loading the workload software application into the processor design model running within the hardware accelerated simulator, and simulating the processor design model running the workload software application within the hardware accelerated simulator. The method further comprises creating, by the hardware accelerated simulator, a point-of-interest checkpoint file. The point-of-interest checkpoint file stores state information for the processor design model at a point of interest. The method further comprises loading the processor design model and the point-of-interest checkpoint file into a software simulator and simulating the processor design model within the software simulator beginning from the point-of-interest checkpoint file to generate input switching and clock gating information for the processor design model. Still further, the method comprises performing, by an on-the-fly power calculator in the software simulator, cycle-by-cycle power estimation based on the input switching and clock gating information.

In one exemplary embodiment, loading the processor design model into the hardware accelerated simulator comprises loading a power on reset checkpoint file into the hardware accelerated simulator. In another exemplary embodiment, loading the workload software application into the processor design model comprises executing a loader executable to accelerate loading of the software application into the processor design model running on the hardware accelerated simulator.

In another exemplary embodiment, creating the point-of-interest checkpoint file comprises periodically creating checkpoint files during hardware accelerated simulation to form a plurality of checkpoint files and identifying a checkpoint file from the plurality of checkpoint files that corresponds to a point of interest in the workload software application.

In a further exemplary embodiment, identifying a checkpoint file from the plurality of checkpoint files comprises examining instruction addresses in the plurality of checkpoint files.

In a still further exemplary embodiment, performing cycle-by-cycle power estimation comprises, for each cycle, building a plurality of macro power models based on the input switching and clock gating information for a given cycle, calculating macro power for each macro power model within the plurality of macro power models based on the input switching and clock gating information for the given cycle, and summing the calculated macro power for the plurality of macro power models to form total macro power for the given cycle. In a further embodiment, performing cycle-by-cycle power estimation using an on-the-fly power calculator further comprises, for each cycle, estimating power due to interconnect capacitance to form net switching power for the given cycle and adding the total macro power and net switching power to form total power for the given cycle.

In another exemplary embodiment, the on-the-fly power calculator is a runtime executable component that executes within the software simulator.

In another illustrative embodiment, a power estimation system is provided for performing power estimation for a processor design model running a workload software application. The power estimation system comprises a hardware accelerated simulator that simulates the processor design model, loads the workload software application into the processor design model, and creates a point-of-interest checkpoint file and a software simulator that simulates the processor design model using the point-of-interest checkpoint file to generate input switching and clock gating information for the processor design model. The power estimation system also comprises an on-the-fly power calculator that performs cycle-by-cycle power estimations based on the input switching and clock gating information.

In other exemplary embodiments, the power estimation system performs various ones of the operations outlined above with regard to the method in the illustrative embodiments.

In yet another illustrative embodiment, a computer program product is provided comprising a computer useable medium having a computer readable program. The computer readable program, when executed on a computing device, causes the computing device to receive a point-of-interest checkpoint file from a hardware accelerated simulator, simulate of the processor design model on a software simulator using the point-of-interest checkpoint file to generate input switching and clock gating information for the processor design model and perform cycle-by-cycle power estimations based on the input switching and clock gating information for the processor design model.

In other exemplary embodiments, the computer readable program may cause the computing device to perform various ones of the operations outlined above with regard to the method in the illustrative embodiments.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a data processing system for which aspects of the illustrative embodiments may be implemented;

FIGS. 2A and 2B illustrate example power estimation systems in accordance with illustrative embodiments;

FIG. 3 is a diagram illustrating operation of an on-the-fly power calculator in accordance with an illustrative embodiment;

FIG. 4 is a flowchart illustrating operation of a power estimation system in accordance with an illustrative embodiment; and

FIG. 5 is a flowchart illustrating operation of an on-the-fly power calculator in accordance with an illustrative embodiment.

### DETAILED DESCRIPTION OF THE PREFERRED EMBODIMENTS

The illustrative embodiments provide a system and method for performing power simulations on complex designs running complex software applications. The illustrative embodiments may be used with any device having a sufficiently complex architecture for which power estimation using software simulation is prohibitive. One such multiprocessor system for which the illustrative embodiments may be implemented is the Cell Broadband Engine (CBE) architecture available from International Business Machines Corporation of Armonk, N.Y. The CBE architecture will be used as an example multiprocessor processing system that may be a device under test with which the illustrative embodiments are implemented for purposes of this description. However, it should be appreciated that the illustrative embodiments are not limited to use with the CBE architecture and may be used with other multiprocessor devices without departing from the spirit and scope of the present invention.

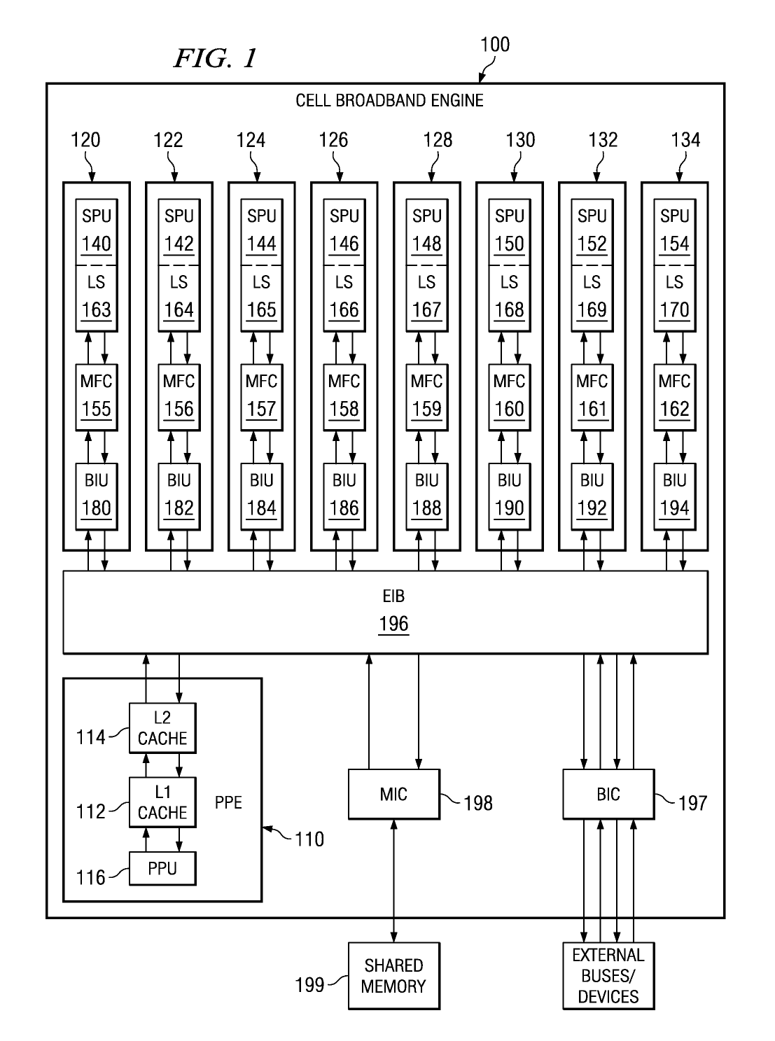

With reference now to the drawings, FIG. 1 is an exemplary block diagram of a data processing system for which aspects of the illustrative embodiments may be implemented. The exemplary data processing system shown in FIG. 1 is an example of the Cell Broadband Engine (CBE) data processing system. While the CBE architecture is described here, the present invention is not limited to such, as will be readily apparent to those of ordinary skill in the art upon reading the following description.

As shown in FIG. 1, the CBE 100 includes a power processor element (PPE) 110 having a processor (PPU) 116 and its L1 and L2 caches 112 and 114, and multiple synergistic processor elements (SPEs) 120-134 that each has its own synergistic processor unit (SPU) 140-154, memory flow control 155-162, local memory or store (LS) 163-170, and bus interface unit (BIU unit) 180-194 which may be, for example, a combination direct memory access (DMA), memory management unit (MMU), and bus interface unit. A high bandwidth internal element interconnect bus (EIB) 196, a bus interface controller (BIC) 197, and a memory interface controller (MIC) 198 are also provided.

The CBE 100 may be a system-on-a-chip such that each of the elements depicted in FIG. 1 may be provided on a single microprocessor chip. Moreover, the CBE 100 is a heterogeneous processing environment in which each of the SPUs may receive different instructions from each of the other SPUs in the system. Moreover, the instruction set for the SPUs may be different from that of the PPU, e.g., the PPU may execute Reduced Instruction Set Computer (RISC) based instructions while the SPU execute vectorized instructions.

The SPEs 120-134 are coupled to each other and to the L2 cache 114 via the EIB 196. In addition, the SPEs 120-134 are coupled to MIC 198 and BIC 197 via the EIB 196. The MIC 198 provides a communication interface to shared memory 199. The BIC 197 provides a communication interface between the CBE 100 and other external buses and devices.

The PPE 110 is a dual threaded PPE 110. The combination of this dual threaded PPE 110 and the eight SPEs 120-134 makes the CBE 100 capable of handling 10 simultaneous threads and over 128 outstanding memory requests. The PPE 110 acts as a controller for the other eight SPEs 120-134 which handle most of the computational workload. The PPE 110 may be used to run conventional operating systems while the SPEs 120-134 perform vectorized floating point code execution, for example.

The SPEs 120-134 comprise a synergistic processing unit (SPU) 140-154, memory flow control units 155-162, local memory or store 163-170, and an interface unit 180-194. The local memory or store 163-170, in one exemplary embodiment, comprises a 256 KB instruction and data memory which is visible to the PPE 110 and can be addressed directly by software.

The PPE 110 may load the SPEs 120-134 with small programs or threads, chaining the SPEs together to handle each step in a complex operation. For example, a set-top box incorporating the CBE 100 may load programs for reading a DVD, video and audio decoding, and display, and the data would be passed off from SPE to SPE until it finally ended up on the output display. At 4 GHz, each SPE 120-134 gives a theoretical 32 GFLOPS of performance with the PPE 110 having a similar level of performance.

The memory flow control units (MFCs) 155-162 serve as an interface for an SPU to the rest of the system and other elements. The MFCs 155-162 provide the primary mechanism for data transfer, protection, and synchronization between main storage and the local storages 163-170. There is logically an MFC for each SPU in a processor. Some implementations can share resources of a single MFC between multiple SPUs. In such a case, all the facilities and commands defined for the MFC must appear independent to software for each SPU. The effects of sharing an MFC are limited to implementation-dependent facilities and commands.

Processor architectures are becoming very complex. One might say that the architectures are becoming “huge”; however, the physical chips themselves are becoming smaller relative to the number of functional components being fabricated on the die area. For example, the Cell Broadband Engine (CBE) architecture is an architecture that extends the 64-bit Power Architecture™ technology. “Power Architecture” is a trademark of International Business Machines Corporation in the United States, other countries, or both. Ideal for computation-intensive tasks like gaming, multimedia, and physics- or life-sciences and related workloads, the CBE architecture is a single-chip multiprocessor no bigger than a fingernail, with eight or more processors operating on a shared, coherent memory. The CBE processor contains one or more Power Architecture™-based control processors (PPUs) augmented with seven or more Synergistic Processor Units (SPUs) and a rich set of DMA commands for efficient communications between processing elements.

The heat generated by high power devices may cause failures if cooling systems are insufficient. While most software may run smoothly without overheating, some code may burden the processor, causing high power consumption and, hence, heat generation. For example, a long loop with highly computation-intensive code may cause a processor to overheat. If a portion of software code causes the processor to generate more heat than can be handled by the cooling system, the processor may fail.

A microprocessor, particularly a multiple core heterogeneous processor such as, for example, the CBE architecture described above with reference to FIG. 1, may be referred to as a very high speed integrated circuit (VHSIC). Engineers may model a circuit like a microprocessor using a hardware description language (HDL). A hardware description language is a language used to describe the functions of an electronic circuit for documentation, simulation, or logic synthesis. Two well-known hardware description languages are VHSIC hardware description language (VHDL) and Verilog, for instance.

A software simulator is a software application that simulates the execution of a hardware design. A software simulator accepts a simulation model in the form of a HDL model. A software simulator may execute on a single computer, on a cluster of computers, or perhaps using grid computing technology. An example of a known software simulator is the MESA simulator, which is a VHDL simulator.

Estimation of power consumption may begin with breaking a design into smaller analytic components. The smaller components are referred to as “macros,” which are essentially smaller block portions of a larger circuit. Examining smaller components of a chip allows for convenience in modeling. Once the processor architecture is broken down into macros, engineers may develop an energy model for each macro. One conventional method is to estimate a switching factor for all blocks in a design Then, vectors based on this switching factor are applied to all blocks and their average power is calculated. This is then aggregated to calculate total chip power. Estimations based on these methods may yield an overall average power consumption; however, these methods do not accurately model the fine grain clock gating that is required in a number of microprocessors today. It also does not provide the time variation of power essential for determining peak power and model the noise on power distribution network.

Full chip simulations for complex processor architectures, such as the CBE architecture described above with reference to FIG. 1, would require a substantial amount of computing resources and time. In addition, conventional methods for power estimation require switching factors to be written to persistent storage during the software simulation, which results in a vast amount of data being stored. A power estimator application must then analyze the data to determine power consumption estimations.

In accordance with the illustrative embodiments, a power estimation system uses a hardware accelerated simulator to advance simulation to a point of interest for power estimation. The hardware accelerated simulator generates a checkpoint file, which is then used by a software simulator to initiate simulation of the processor design model for power estimation. An on-the-fly power estimator provides power calculations in memory. Thus, the power estimation system described herein isolates instruction sequences to determine portions of software code that may consume excess power or generate noise and to provide a more accurate power estimate on the fly.

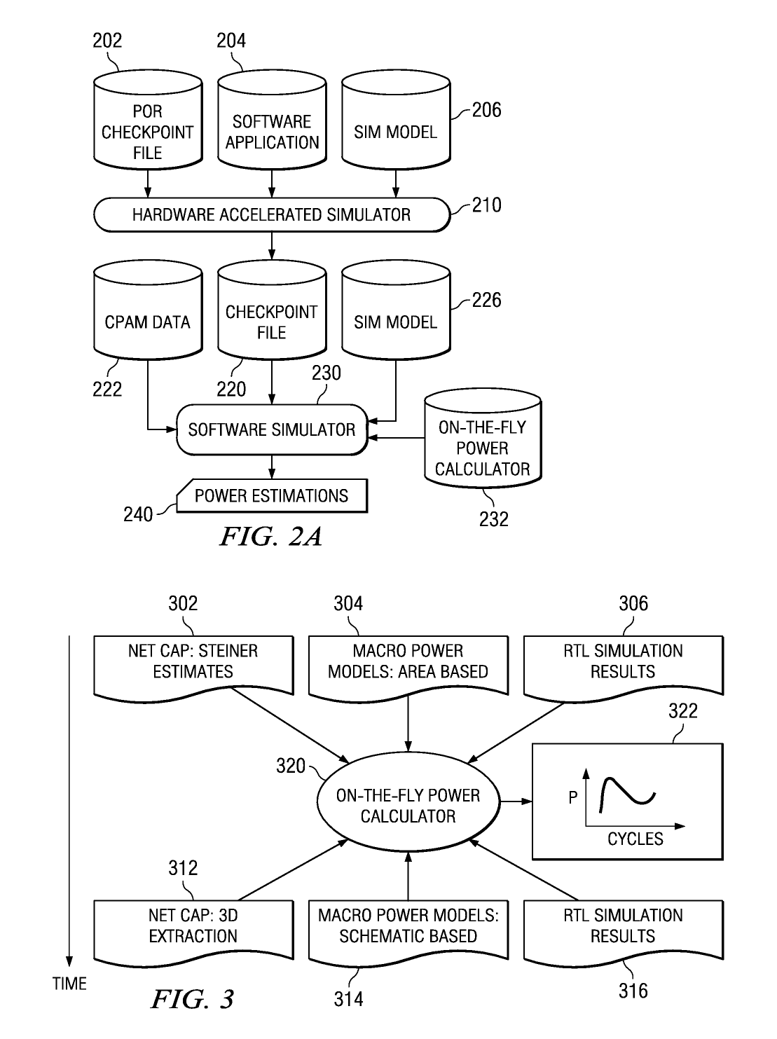

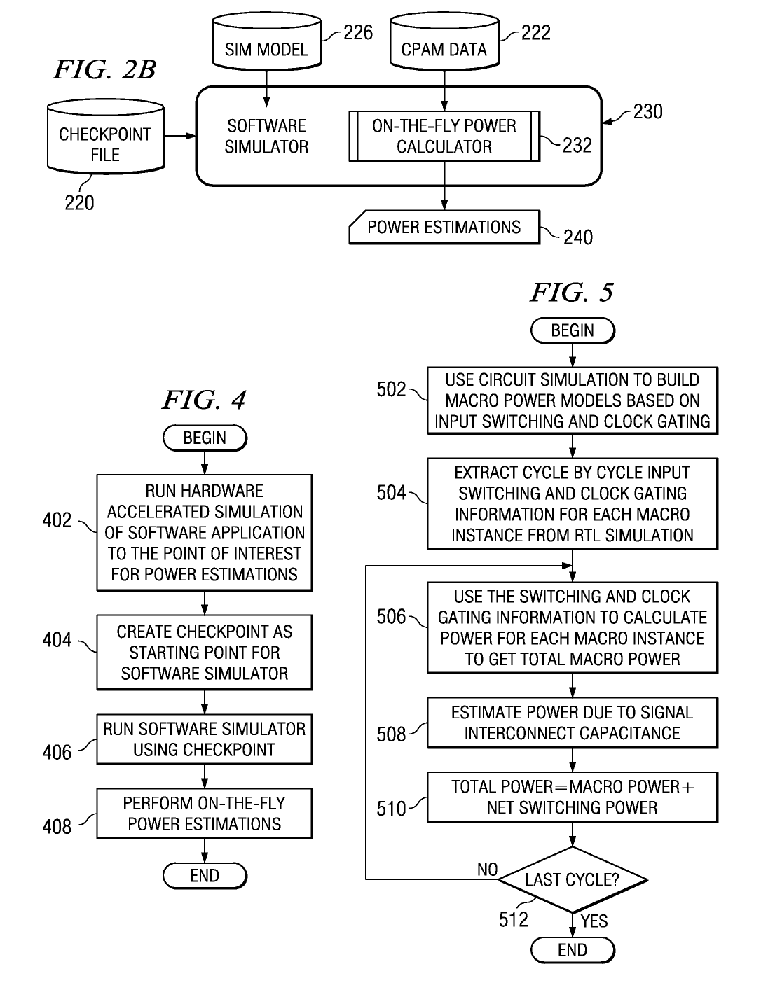

FIGS. 2A and 2B illustrate example power estimation systems in accordance with an illustrative embodiment. More particularly, with reference to FIG. 2A, hardware accelerated simulator 210 receives power on reset (POR) checkpoint file 202, software application 204, and simulation model 206. Hardware accelerated simulator 210 runs for a predetermined number of cycles, or until a particular sequence of software code is being executed, and generates checkpoint file 220. A known example of a hardware accelerated simulator is the AWAN simulator. The hardware accelerated simulator (AWAN) provides a hardware assist to emulate the behavior of the design under test. The simulator has thousands of processors, which can emulate millions of gates. This provides high performance simulation. The simulation is orders of magnitude faster than traditional software simulation environments.

Checkpointing is a function provided by known hardware accelerated simulators and software simulators. Checkpointing saves the states of all the latches and other inputs that have been set to a desired value at a specified point in time. The state of all the combinational logic does not need to be preserved, because the state of the latches and input/output (I/O) will propagate through the combinational logic at the time the checkpoint is restored. In other words, checkpoint file 220 is a snapshot of the state of the simulation model at a particular point in time.

A point-of-interest checkpoint file is a checkpoint file that stores the state of the simulation model at a point of interest. The point of interest may be a point within the software application being executed. For example, a point-of-interest checkpoint file may be a checkpoint file taken when a particular instruction address is encountered. Alternatively, a point-of-interest checkpoint file may be taken at other points of interest. For example, a point-of-interest checkpoint file may store state information for the simulation model at a particular point in time, such as after running the software application for a predetermined number of hours.

For complex processor architectures, the startup process of doing power on reset, self test, a serial flush of all latches, register initialization, and starting functional clocks is a complicated and time-consuming task. Power on reset checkpoint file 202 allows the simulation to begin at the end of this process. Engineers who specialize in this testing may create power on reset checkpoint file 202.

The next step of the simulation process is to get the software application 204 loaded and the processor's execution of this application started. Software application 204 is a workload software application to be executed on the device under test. Simulation model 206 represents the processor hardware. Simulation model 206 may be represented using a hardware description language, such as VHDL, for example. Loading an application is a very lengthy operation if the workload application is loaded by the serial process used in a lab. Even with hardware acceleration, loading the workload application 204 would be very time consuming and prone to error. A loader may be provided to accelerate the loading of the workload application into the memory of the chip architecture as generally known in the art. The loader may be included as a module in a run time executable (RTX). The use of a RTX loader may reduce the loading time from hours or days to a few minutes.

RTX components (run time executable) are the controlling software of the simulation environment. This software can have a wide variety of function and interaction with the design under test. When using hardware accelerated simulation, there is a significant penalty for probing the model of the design under test. A reduced function RTX can be used when it is not necessary to check or modify the designs behavior during the simulation to receive the greatest performance from the simulator. When the application workload is loaded onto the design, a larger, fuller function RTX is used to initialize the design and memory with the application workload, and the software simulator is used.

The workload application itself requires its own setup and initialization, which may require millions of simulation cycles to be run before processing cores are running the instructions for which power measurements are to be performed. Hardware accelerated simulator 210 focuses on running software application 204 on simulation model 206 with a higher performance than that of a software simulator. Hardware accelerated simulator 210 may display instruction addresses periodically—every two thousand cycles, for example—to show that the simulation is progressing.

In this context, “software simulator” refers to the entire simulation environment, which includes the simulator itself and all controlling software, such as RTX components. The simulator itself allows RTX components to add functionality, such as software loaders, for example. In the illustrated embodiment, software simulator 230 loads on-the-fly calculator 232, which is a controlling software component, described in further detail below.

An operator may identify checkpoint file 220, generated by hardware accelerated simulator 210, to be used to begin software simulation for power estimation. The operator may examine instruction addresses to determine whether the hardware accelerated simulation has advanced to a portion of code that is of interest. A software simulator, such as software simulator 230, is faster for creating traces. Therefore, software simulator 230 receives checkpoint file 220, common power analysis methodology (CPAM) data 222, and simulation model 206 to begin software simulation. Software simulator 230 may be a known software simulator, such as the MESA simulator. Simulation model 206 and simulation model 226 may be the same model, such as a VHDL model for instance; however, simulation model 206 may be compiled for hardware accelerated simulator 210 and simulation model 226 may be compiled for software simulator 230.

Software simulator 230 also receives and loads on-the-fly power calculator 232. As software simulator 230 runs simulation cycles, it also runs on-the-fly power calculator 232 to generate power consumption numbers on a cycle-by-cycle basis. Software simulator 230 outputs the cycle-by-cycle power consumption numbers as power estimations 240.

On-the-fly power calculator 232 provides a tool that provides accurate, cycle-by-cycle power estimates due to heavy use of fine grain clock gating. On-the-fly power calculator 232 provides an accurate transistor-level power simulation for a high percentage of custom macros with unique circuit topologies including arrays and dynamic circuits. Software simulator 230 simulates thousands of cycles to estimate power for different workloads. This provides a high throughput register transfer level (RTL) simulation to verify the RTL and circuit implementation of the design and to estimate active workload-dependent power.

Switching power of a circuit in a given cycle is defined by the following equation:

P=1/2CV²f

where C is the total node capacitance switched, V is the power supply voltage, and f is the clock frequency. The factors affecting switching node capacitance (C) are input switching and clock gating in the circuit.

As seen in FIG. 2B, on-the-fly calculator 232 may be implemented as a component that runs within the environment of software simulator 230. On-the-fly calculator 232 loads CPAM data 222 and communicates with other components of software simulator 230 to receive simulation results on a cycle-by-cycle basis. On-the-fly calculator 232 then outputs the cycle-by-cycle power consumption numbers as power estimations 240.

FIG. 3 is a diagram illustrating operation of an on-the-fly power calculator in accordance with an illustrative embodiment. On-the-fly power calculator tool 320 uses circuit simulation to build macro power models based on input switching and clock gating. On-the-fly power calculator 320 extracts cycle-by-cycle input switching and clock gating information for each macro instance from RTL simulation 306, 316.

On-the-fly power calculator 320 uses the switching and clock gating information to calculate power for each macro instance to get total chip power for all macros. Power due to signal interconnect capacitance may be estimated using signal switching information or interconnect capacitance estimate using Steiner routes 302 or three-dimensional (3D) extraction 312. Total power is equal to macro power plus net switching power. The on-the-fly power calculator repeats this calculation for every cycle and outputs cycle-by-cycle power estimates 322.

A macro is defined as the lowest level block of the design hierarchy in a floorplan. A macro may range from hundreds to thousands of gates. The macro power model may be created using the Common Power Analysis Methodology (CPAM) tool, for example, which is available from International Business Machines Corporation. The macro power model may be area based 304 or schematic based 314. Input switching factor is defined as the percent of inputs switching state between two consecutive clock cycles.

CPAM, for example, runs random vectors on the schematic 314 using multiple switching factors under two conditions. The first condition is all clock buffers turned on for fully clock active power. The second condition is all clock buffers forced off to get fully clock gated power.

Register transfer level (RTL) simulations are done using a software simulator, such as, for example, the MESA simulator from International Business Machines Corporation. For each macro instance, the state of each input is monitored at cycle boundaries to measure the input switching factor. The switching of each global net is monitored to calculate interconnect switching power.

Clock activity for custom macros is measured by monitoring all clock buffers that are turned on in the macro. The designers provide a table (not shown) with relative power weights for each clock buffer. The clock activity is determined by adding the weights of the clock buffers that are turned on. For synthesized macros, clock activity is measured by the percent of latch bits that are active in the given cycle.

Using clock activity and input switching factors for each macro instance in a cycle, the total power in a given cycle C may be calculated by the following equation:

Total Power (C)=ΣBlkPwr(SF, CLK)+½Cₙₑₜ(C)V²f

where Cₙₑₜ is the total interconnect capacitance switched, V is the power supply voltage, and f is the clock frequency.

FIG. 4 is a flowchart illustrating operation of a power estimation system in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be embodied in a computer-readable memory, storage medium, or transmission medium that can direct a processor or other programmable data processing apparatus to function in a particular manner, such that the instructions stored in the computer-readable memory, storage medium, or transmission medium produce an article of manufacture including instruction means that implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With particular reference to FIG. 4, operation begins and the power estimation system runs hardware accelerated simulation of a processor model executing a particular software application to the point of interest for power estimations (block 402). The hardware accelerated simulation creates a checkpoint as a starting point for a software simulator (block 404). Next, the power estimation system runs the software simulator using the checkpoint (block 406). The software simulator uses an on-the-fly power calculator to perform cycle-by-cycle power estimations (block 408). Thereafter, operation ends.

FIG. 5 is a flowchart illustrating operation of an on-the-fly power calculator in accordance with an illustrative embodiment. Operation begins and the on-the-fly power calculator uses circuit simulation to build macro power models based on input switching and clock gating (block 502). The on-the-fly power calculator extracts cycle-by-cycle input switching and clock gating information for each macro instance from register transfer level simulation (block 504).

Then, the on-the-fly power calculator uses the switching and clock gating information to calculate power for each macro instance to get total macro power for the processor architecture (block 506). The on-the-fly power calculator estimates power due to signal interconnect capacitance (block 508). The on-the-fly power calculator determines the total power to be the total macro power plus net switching power (block 510).

The on-the-fly power calculator determines whether the current cycle is the last cycle for software simulation and power estimation (block 512). If the current cycle is not the last cycle, operation returns to block 506 to calculate power for the next cycle. If the current cycle is the last cycle in block 512, then operation ends.

Thus, the illustrative embodiments solve the disadvantages of the prior art by providing a power estimation system that uses a hardware accelerated simulator to advance simulation to a point of interest for power estimation. The hardware accelerated simulator generates a checkpoint file, which is then used by a software simulator to initiate simulation of the processor design model for power estimation. An on-the-fly power estimator provides power calculations in memory. Thus, the power estimation system described herein isolates instruction sequences to determine portions of software code that may consume excess power or generate noise and to provide a more accurate power estimate on the fly.

It should be appreciated that the illustrative embodiments described above may take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

As described previously above, a data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing power estimation for a processor design model running a workload software application, the method comprising:
loading the processor design model into a hardware accelerated simulator;
loading the workload software application into the processor design model running within the hardware accelerated simulator;
simulating the processor design model running the workload software application within the hardware accelerated simulator;
creating, by the hardware accelerated simulator, a point-of-interest checkpoint file, wherein the point-of-interest checkpoint file stores state information for the processor design model at a point of interest;
loading the processor design model and the point-of-interest checkpoint file into a software simulator;
simulating the processor design model within the software simulator beginning from the point-of-interest checkpoint file to generate input switching and clock gating information for the processor design model; and
performing, by an on-the-fly power calculator in the software simulator, cycle-by-cycle power estimation based on the input switching and clock gating information.

2. The method of claim 1, wherein loading the processor design model into the hardware accelerated simulator comprises:
loading a power on reset checkpoint file into the hardware accelerated simulator.

3. The method of claim 1, wherein loading the workload software application into the processor design model comprises executing a loader executable to accelerate loading of the software application into the processor design model running on the hardware accelerated simulator.

4. The method of claim 1, wherein creating the point-of-interest checkpoint file comprises:
periodically creating checkpoint files during hardware accelerated simulation to form a plurality of checkpoint files; and
identifying a checkpoint file from the plurality of checkpoint files that corresponds to a point of interest in the workload software application.

5. The method of claim 4, wherein identifying a checkpoint file from the plurality of checkpoint files comprises:
examining instruction addresses in the plurality of checkpoint files.

6. The method of claim 1, wherein performing cycle-by-cycle power estimation comprises for each cycle:
building a plurality of macro power models based on the input switching and clock gating information for a given cycle;
calculating macro power for each macro power model within the plurality of macro power models based on the input switching and clock gating information for the given cycle; and
summing the calculated macro power for the plurality of macro power models to form total macro power for the given cycle.

7. The method of claim 6, wherein performing cycle-by-cycle power estimation using an on-the-fly power calculator further comprises for each cycle:
estimating power due to interconnect capacitance to form net switching power for the given cycle; and
adding the total macro power and net switching power to form total power for the given cycle.

8. The method of claim 1, wherein the on-the-fly power calculator is a runtime executable component that executes within the software simulator.

9. A power estimation system for performing power estimation for a processor design model running a workload software application, the power estimation system comprising:
a hardware accelerated simulator that simulates the processor design model, loads the workload software application into the processor design model, and creates a point-of-interest checkpoint file;
a software simulator that simulates the processor design model using the point-of-interest checkpoint file to generate input switching and clock gating information for the processor design model; and
an on-the-fly power calculator that performs cycle-by-cycle power estimations based on the input switching and clock gating information.

10. The power estimation system of claim 9, wherein the hardware accelerated simulator initiates simulation of the processor design model using a power on reset checkpoint file.

11. The power estimation system of claim 9, further comprising:
a loader executable that accelerates loading of the workload software application into the processor design model running on the hardware accelerated simulator.

12. The power estimation system of claim 9, wherein the hardware accelerated simulator periodically creates checkpoint files during hardware accelerated simulation to form a plurality of checkpoint files, wherein the plurality of checkpoint files includes the point-of-interest checkpoint file.

13. The power estimation system of claim 9, wherein for each cycle the on-the-fly power calculator builds a plurality of macro power models based on the input switching and clock gating for a given cycle, calculates macro power for each macro power model within the plurality of macro power models based on the input switching and clock gating information for the given cycle, and sums the macro power for the plurality of macro power models to form total macro power for the given cycle.

14. The power estimation system of claim 13, wherein for each cycle the on-the-fly power calculator estimates power due to interconnect capacitance to form net switching power for the given cycle and adds the total macro power and net switching power to form total power for the given cycle.

15. The power estimation system of claim 9, wherein the on-the-fly power calculator runs within the software simulator.

16. The power estimation system of claim 15, wherein the on-the-fly power calculator is a runtime executable component that executes within the software simulator.

17. A computer program product comprising a computer useable medium having a computer readable program, wherein the computer readable program, when executed on a computing device, causes the computing device to:
receive a point-of-interest checkpoint file from a hardware accelerated simulator;
simulate of the processor design model on a software simulator using the point-of-interest checkpoint file to generate input switching and clock gating information for the processor design model; and
perform cycle-by-cycle power estimations based on the input switching and clock gating information for the processor design model.

18. The computer program product of claim 17, wherein for each cycle, the computer readable program causes the computing device to perform cycle-by-cycle power estimations by:
building a plurality of macro power models based on input switching and clock gating for a given cycle;
calculating macro power for each macro power model within the plurality of macro power models based on the input switching and clock gating information for the given cycle; and
summing the macro power for the plurality of macro power models to form total macro power for the given cycle.

19. The computer program product of claim 18, wherein for each cycle the computer readable program further causes the computing device to perform cycle-by-cycle power estimations by:
estimating power due to interconnect capacitance to form net switching power for the given cycle; and
adding the total macro power and net switching power to form total power for the given cycle.

20. The computer program product of claim 17, wherein the computer readable program further causes the computing device to:
load an on-the-fly power calculator, wherein the on-the-fly power calculator executes within the software simulator to calculate cycle-by-cycle power estimations.
